(19) United States
(12) Patent Application Publication
(10) Pub. No.: US 2020/0118396 A1
(43) Pub. Date: Apr. 16, 2020

(54) MULTI-PANEL FOLDABLE ARMOR DEVICE

(71) Applicant: EMSN INITIATIVE AND RESOLUTIONS 2013 LTD., Lod (IL)

(72) Inventors: SHMUEL NEUFELD, LOD (IL); ELAZAR MODIZINSKY, BEIT EL (IL)

(21) Appl. No.: 16/159,669

(22) Filed: Oct. 14, 2018

(51) Int. Cl. G07F 19/00

(52) U.S. Cl. CPC G07F 19/205

(57) ABSTRACT

A multi-panel foldable armor device comprises multiple foldable armored panels bound in a continuous structure configured to be altered between a folded-position and an unfolded-position, wherein each foldable armored panel is bound to at least one adjacent foldable armored panel by a hinge set. The multi-panel foldable armor comprises a rear armored panel designed to extend perpendicularly to a horizontal surface. The multi-panel foldable armor also comprises a bottom foldable armored panel pivotally connected by a third hinge set to the rear armored panel, wherein the third hinge set is configured such that at the folded-position the bottom foldable armored panel is folded over the rear armored panel, and wherein the third hinge set is configured such that at the unfolded-position the bottom foldable armored panel is situated perpendicularly to the rear armored panel.

### FIELD

The present disclosure generally relates to a device for protecting automated teller machines (ATMs) and vending machines, and more particularly relates to easily assembled armor for protecting ATMs and vending machines from tampering.

### BACKGROUND

Portable automated teller machines are generally designed to be light and portable and are especially vulnerable to theft, particularly when located at outdoor venues and away from buildings. ATMs and vending machines are tending to be targeted by outlaws intending to steal cash contained and protected within the ATMs and vending machines. One of the methods outlaws use to steal the cash comprising brute force approaches such as drilling out or cutting the automated teller machines, and gaining access to the money. In other cases, the outlaws may pick up the entire ATM from its place to be raided at a safer location.

In order to prevent such tampering, ATM's and vending machines are typically situated inside an armor and connected to the armor, which provides a certain amount of protection against tampering. In some cases, armors for ATMs may be formed from heavy steel plates welded together, which provides an immovable and expensive option for providing heavy protection for the ATM contained inside. Such armors for ATMs may be built and assembled in the factory and are moved to the desired ATM location in the assembled form. Due to the dimensions of typical armors, the armor is transferred in a truck or a container, occupying a large space which is typically bigger than the ATM designated to be stored therein. Sometimes, the ATMs or vending machines are manufactured with a built-in armor for preventing tampering thereof, thus making the ATMs itself heavier to be moved around.

Nonetheless, the aforementioned systems are not suitable for ATMs and vending machines that are temporarily positioned and change location frequently due to the amount of effort required to assemble and separate the ATM from the armor or to transport the armor. Thus, there is a need in the art for a convenient solution for providing protection against tampering which is easily transported and quick to assemble and disassemble.

### SUMMARY

The subject matter depicted in the invention disclosed multi-panel foldable armor device comprises multiple foldable armored panels bound in a continuous structure configured to be altered between a folded-position and an unfolded-position, wherein each foldable armored panel is bound to at least one adjacent foldable armored panel by a hinge set. The multi-panel foldable armor comprises a rear armored panel designed to extend perpendicularly to a horizontal surface. The multi-panel foldable armor also comprises a bottom foldable armored panel pivotally connected by a third hinge set to the rear armored panel, wherein the third hinge set is configured such that at the folded-position the bottom foldable armored panel is folded over the rear armored panel, and wherein the third hinge set is configured such that at the unfolded-position the bottom foldable armored panel is situated perpendicularly to the rear armored panel.

The multi-panel foldable armor also comprises a first side foldable armored panel pivotally connected by a first hinge set to the rear armored panel, wherein the first hinge is configured such that at the folded-position the first side foldable armored panel is folded over the folded bottom foldable armored panel wherein the folded bottom foldable armored panel is folded over the rear armored panel, and wherein the first hinge is configured such that at the unfolded-position the first side foldable armored panel is situated perpendicularly to the rear armored panel.

The multi-panel foldable armor also comprises a front foldable armored panel pivotally connected by a forth hinge set to the first side foldable armored panel, wherein the forth hinge set is configured such that at the folded-position the front foldable armored panel is folded over the first side foldable armored panel, and wherein the forth hinge set is configured such that at the unfolded-position the front foldable armored panel is situated perpendicularly to the first side foldable armored panel.

The multi-panel foldable armor also comprises a second side foldable armored panel pivotally connected by a second hinge set to the rear armored panel, wherein the second hinge set is configured such that at the folded-position the second side foldable armored panel is folded over the folded first side foldable armored panel wherein the folded first side foldable armored panel is folded over the folded bottom foldable armored panel wherein the folded bottom foldable armored panel is folded over the rear armored panel, and wherein the second hinge set is configured such that at the unfolded-position the second side foldable armored panel is situated perpendicularly to the rear armored panel.

The multi-panel foldable armor can be also configured such that at unfolded-position the bottom foldable armored panel situated perpendicularly to the rear armored panel is mounted to the first side foldable armored panel and thereby prevents from the first side foldable armored panel to rotate on the first hinge set, and wherein the at unfolded-position the bottom foldable armored panel situated perpendicularly to the rear armored panel is mounted to the second side foldable armored panel and thereby prevents from the second side foldable armored panel to rotate on the second hinge set.

In some embodiments of the disclosed subject matter, the first side foldable armored panel further comprises a first side rail member. The first side rail member can be utilized to mount the bottom foldable armored panel to the first side foldable armored panel. In some cases, the first side rail member comprises a first elevated platform utilized by the first side rail member to operably mount the bottom foldable armored panel to the first side foldable armored panel. The bottom foldable armored panel further comprises a second side rail member. The second side rail member can be utilized to mount the bottom foldable armored panel to the second side foldable armored panel. In some cases, the second side rail member comprises a second elevated platform utilized by the second side rail member to operably mount the bottom foldable armored panel to the second side foldable armored panel. In some embodiments of the disclosed subject matter, the bottom foldable armored panel further comprises apertures configured to allow a passage of a connector from the foldable armor into a horizontal surface below the foldable armor.

In some embodiments of the disclosed subject matter, the front foldable armored panel further comprises a locking mechanism aperture. The locking mechanism aperture may be located adjacent to the front second lateral side. The locking mechanism may house a locking mechanism configured to be held against the second side foldable armored panel wherein the foldable armor is at the unfolded-position. The multi-panel foldable armor may be designed as portable device configured to be structured in an unfolded-position and in a folded position. In some cases, the foldable armor may weigh 100 Kgs or less. In some cases, the foldable armored panels are formed with the same thickness. In one aspect of the disclosed subject matter other, the bottom foldable armored panels may be thicker than the rear foldable armored panels. In one aspect of the disclosed subject matter other, the bottom foldable armored panels may be thicker than the first side foldable armored panels. In one aspect of the disclosed subject matter other, the bottom foldable armored panels may be thicker than the second side foldable armored panels.

### BRIEF DESCRIPTION OF THE DRAWINGS

The invention may be more clearly understood upon reading of the following detailed description of non-limiting exemplary embodiments thereof, with reference to the following drawings, in which:

FIG. 1 discloses an ATM which can be protected by a multi-panel foldable armor, according to known prior art;

FIG. 2 discloses an ATM placed within a foldable armor with multiple foldable armored panels bound in a continuous structure in an unfolded-position, according to exemplary embodiments of the subject matter;

FIG. 3 discloses a rear armored panel of a multi-panel foldable armor, according to exemplary embodiments of the subject matter;

FIG. 4 discloses a first side foldable armored panel of a multi-panel foldable armor, according to exemplary embodiments of the subject matter;

FIG. 5 discloses a second side foldable armored panel of the multi-panel foldable armor, according to exemplary embodiments of the subject matter;

FIG. 6 discloses a bottom foldable armored panel of the multi-panel foldable armor, according to exemplary embodiments of the subject matter;

FIG. 7A discloses the foldable armor with multiple foldable armored panels bound in a continuous structure at a folded position, according to exemplary embodiments of the subject matter;

FIG. 7B discloses the multi-panel foldable armor with multiple foldable armored panels bound in a continuous structure arranged in a transitional layout, denoted as a first unfolding position, which leads to the unfolded-position of the multi-panel foldable armor, according to FIG. 7A;

FIG. 7C discloses the multi-panel foldable armor with multiple foldable armored panels bound in a continuous structure arranged in a transitional layout, denoted as a second unfolding position, which leads to the unfolded-position of the multi-panel foldable armor, according to FIG. 7A;

FIG. 7D discloses the multi-panel foldable armor with multiple foldable armored panels bound in a continuous structure in an unfolded-position, according to FIG. 7A;

FIG. 8. shows a cross-section of a lower section of a multi-panel foldable armor in an unfolded-position, according to exemplary embodiments of the subject matter;

FIG. 9 discloses a front foldable armored panel of the multi-panel foldable armor, according to FIG. 7C; and

FIG. 10 discloses a horizontal cross-section of a foldable armor in an unfolded-position, according to exemplary embodiments of the subject matter.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION

The invention described herein discloses a multi-panel foldable armor device, also denoted as a foldable armor device for protecting ATMs. The multi-panel foldable armor device comprises a number of panels configured to switch positions between folded and unfolded-positions wherein the panels are configured to fold one over the other. The folded-position of the multi-panel foldable armor allows the multi-panel foldable armor to be easily transportable, compactly designed, and lightweight compared to other armors. The term “ATM” as mentioned herein depicts Automated Teller Machines (ATMs), vending machines and other devices that store money or goods within at a designated location and are configured to selectively receive and/or distribute the stored money or goods. Some examples for such vending machines and other devices may include: soft drinks machines, arcade machines, vaults, box office, jackpot, safes and the like. The term “hinge” as mentioned herein depicts a movable joint on which a door, gate, or lid pivots. A hinge can be a mechanical bearing that connects two solid objects. In some cases, the hinge is designed to allow only a limited angle of rotation between the two objects connected by the hinge. The hinges utilized in the multi-panel foldable armorare utilized as binding elements which bind the panels of the multi-panel foldable armor to a continuous structure configured to be in a folded-position and unfolded-position, and to switch between the positions, as described below.

The invention allows ATM owners and operators to increase ATMs' security in cases temporary deployment of ATMs is required. The multi-panel foldable armor can be easily assembled into an unfolded-position and disassembled into a folded-position by a person. In some cases, the multi-panel foldable armor can be configured such that the assemble and disassemble processes of the multi-panel foldable armor can be manually operated without requiring any tools or instruments for facilitating the assemble and disassemble processes. In such cases the multi-panel foldable armor may be assembled and disassembled conveniently in the designated location thereof. The ATM configuration allowing manual operation can provide a protection for portable ATM's. Portable ATM's can be ATM's situated in temporary locations such as festivals, concerts, events and the like. Although the figures illustrate a certain model of ATM and foldable armor for exemplary purposes, the disclosed invention is not limited to any model or manufacturer. The features, installation, and operation of the armor components described herein may be adapted to any ATM model. The term “internal” as mentioned herein depicts the directions of the of the multi-panel foldable armor, wherein the internal surfaces directs towards an interior volume of the multi-panel foldable armor in case the multi-panel foldable armor in the unfolded-position. The term “external” as mentioned herein depicts the directionality of a number of surfaces of panels of the multi-panel foldable armor, wherein the external surfaces directs/points outward from the multi-panel foldable armor when the multi-panel foldable armor in the unfolded-position.

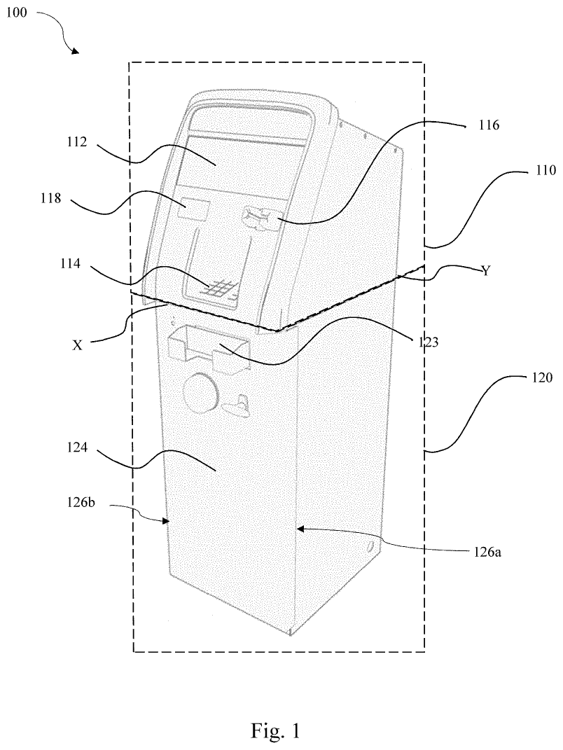

FIG. 1 discloses an ATM which can be protected by a multi-panel foldable armor, according to known prior art. FIG. 1 shows an ATM 100 comprising an interface section 110 configured to be accessible to a person utilizing and operating the ATM 100. The interface section 110 comprises components enabling persons to interact with the ATM 100 for performing financial transactions. In most cases, the interface section 110 is in communication connection with a computer (not shown) located inside the ATM 100. The computer is also connected to a display 112 for presenting information to the person utilizing the ATM 100. In some cases, a keypad 114 for enabling the person to enter a pin code is also connected to the computer located inside the ATM 100. In some cases, a card reader 116 enabling the ATM to read card-shaped storage mediums. In some cases, the computer of the ATM 100 may also be connected to a printer 118 for printing financial transaction receipts, or to print other documents acknowledging that a person has committed financial translations. In some cases, the interface portion 110 may comprise other components, such as cameras, power supplies, speakers, and the like. In some embodiments of the invention, the display 112 may be combined with the keypad 114 in the form of a touch screen, enabling the person to interact directly with the display 112.

The ATM 100 also comprises a safe section 120 configured to be inaccessible to persons utilizing and operating the ATM 100., The safe section 120 is also configured to be accessible only to the owner and/or other persons in charge of the ATM for replenishment of cash stored within the safe section 120. The safe section 120 is positioned below the interface section 110 and is typically formed from a thick metal box (in contrast to the typically plastic design of the interface section 110 above the safe section). the safe section 120 is the part positioned below the plane obtained from both axis X and Y. The safe section 120 comprising a safe (not shown) and a cash distributing mechanism 123 located at a front surface of the ATM 100. The safe can be utilized for distributing cash stored in the safe to persons utilizing and/or operating the ATM 100. The safe section 120 may also comprise a safe door 124 located on a front side of the safe section 120. In some cases, the safe door 124 comprises a hinged side 126A and a safe door opening side 126B. The safe door opening side 126B may be positioned opposite to the hinged side 126A. In some cases, the safe door 124 can be exploited as the primary target for tampering the ATM 100. The safe door 124 is a weak point which makes at the ATM 100 vulnerable to various forms of attack. For example, a vertical seam (not shown) located at the safe door opening side 126B of the safe door 124 is a common and vulnerable location for attacks, for example, by a crowbar applying brute force on the safe door to fold the safe door 124 or to crack the safe door 124 locks. In some ATMs such as ATM 100, a plurality of holes (not shown) may be drilled through a bottom surface of the safe section 120. In some cases, the holes are configured to enable ground connectors such as anchor bolts to be inserted from the safe section and through the holes, for securing the ATM 100 to a solid base or horizontal surface beneath the ATM 100. In such cases, horizontal surface connectors fasten the ATM attachment to the horizontal surface for preventing the ATM 100 from being portable.

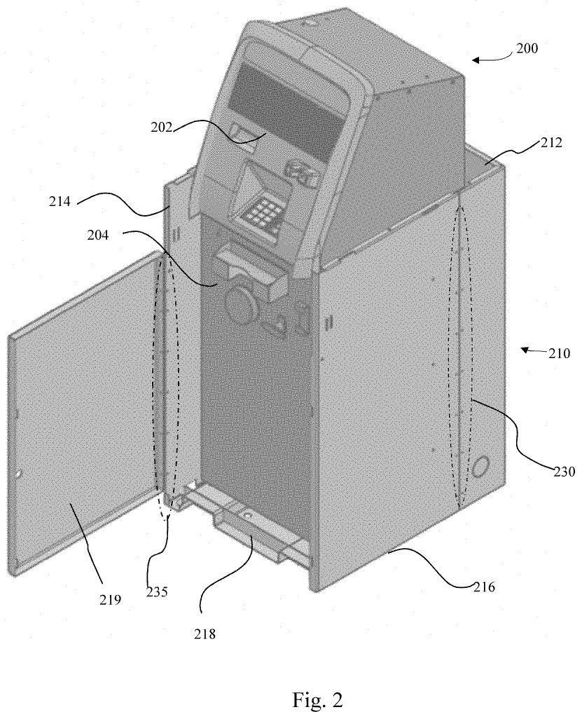

FIG. 2 discloses an ATM placed within a foldable armor with multiple foldable armored panels bound in a continuous structure in an unfolded-position, according to exemplary embodiments of the subject matter. FIG. 2 shows an ATM 200 comprising an interface section 202, and a safe section 204. The ATM 200 also comprises a multi-panel foldable armor 210 in an unfolded-position covering at least a part of the ATM 200. The multi-panel foldable armor 210 may be formed and designed to provide the safe part of the ATM 200 with external shielding which protects the safe section 204 against sabotage and/or tampering. Such a sabotage and/or tampering may comprise, drilling, applying brute force, cutting and other tampering or sabotage used to break through ATM's.

The multi-panel foldable armor 210 comprises a rear armored panel 212 located at the rear side of the multi-panel foldable armor 210. The rear armored panel 212 is pivotally connected to a first side foldable armored panel 214 by a first hinge set (not shown). Such a first hinge set comprises at least two hinges designed to be binding elements which bind between the rear armored panel 212 and the first side foldable armored panel 214 to a continuous structure and allow the swinging movement as the first side foldable armored panel 214 opens and closes. The first side foldable armored panel 214 is also pivotally connected to the front foldable armored panel 219 by a forth hinge set 235. The forth hinge set 235 comprises at least two hinges designed to be binding elements which binds between the first side foldable armored panel 214 and the front foldable armored panel 219 to a continuous structure and allow the swinging movement as the front foldable armored panel 219 opens and closes.

The rear armored panel 212 is also pivotally connected to the second side foldable armored panel 216 by a second hinge set 230. The second hinge set 230 comprises at least two hinges designed as binding elements which bind between the rear armored panel 212 and the second side foldable armored panel 216 to a continuous structure and allow the swinging movement as the second side foldable armored panel 216 opens and closes. The multi-panel foldable armor 210 may also comprise a bottom foldable armored panel 218 designed to be positioned below the safe section 204. In some cases, the bottom foldable armored panel 218 is may be adapted to be pivotally connected to the rear armored panel 212 by a third hinge set (not shown). In some cases, the bottom foldable armored panel 218 may comprise rail members designed to be mounted to the lower parts of the second side foldable armored panel 216 and the first side foldable armored panel 214, as explained below. Such a third hinge set comprises at least two hinges designed to connect between the bottom foldable armored panel 218 and the rear armored panel 212 to a continuous structure and allow the swinging movement as the bottom foldable armored panel 218 unfolds and folds.

The pivotally connected foldable armored panels such as the bottom foldable armored panel 218, front foldable armored panel 219, second side foldable armored panel 216, and the first side foldable armored panel 214 may be configured to put the multi-panel foldable armor 210 in folded and unfolded-positions by rotating the pivotally connected foldable armored panels. In some cases, the pivotally connected foldable armored panels may be configured such that rotating thereof to a folded or unfolded-position may require rotating the pivotally connected foldable armored panels in a certain predefined order. For example, the pivotally connected foldable armored panels may be configured such that the second side foldable armored panel 216 may be required to rotate around the rear armored panel 212, and only then, to rotate the first side foldable armored panel 214.

In some embodiments of the invention, the multi-panel foldable armored panels of the multi-panel foldable armor 210 may be formed of different materials and/or have a different thicknesses and properties. In possible embodiments of the invention, the multi-panel foldable armored panels may be formed of the same materials and in some cases, may comprise the same thicknesses. In some embodiments of the invention, the multi-panel foldable armor 210 is designed to be in such a scale which minimizes the vacant spaces remained between the multi-panel foldable armor 210 and the ATM 200 residing therein. In such cases, the ATM 200 may be comfortably inserted into the multi-panel foldable armor 210 in addition to prevent vacant space inside the multi-panel foldable armor 210, which may ease tampering the ATM 200.

In some cases, the multi-panel foldable armor 210 is designed to be shaped as a box in cases the multi-panel foldable armor 210 is in an unfolded-position. The multi-panel foldable armor 210 is further configured to be folded into a folded-position, wherein the transition between the unfolded-position and the folded-position is made by rotating at least some of the multi-panel foldable armored panels of the multi-panel foldable armor 210. As shown in FIG. 2, in cases the multi-panel foldable armor 210 is at an unfolded-position, the first side foldable armored panel 214 is situated essentiality in parallel to the second side foldable armored panel 216. In some cases, both the first side and the second side foldable armored panels 214 and 216 may be essentiality perpendicular to the rear armored panel 212 and to the front foldable armored panel 219. In some cases, the thickness of the rear, first side, second side and front foldable armored panels is between 0.15 and 0.25 centimeters (CM). In some cases, the thickness of the bottom foldable armored panel 218 between 0.25 and 0.35 CM.

In some embodiments of the invention, at least some of the multi-panel foldable armored panels extend to the same predetermined height. In some cases, the predetermined height is at least in the height of the top surface of the safe section of the ATM 200, as aforementioned. In some cases, the at least some of the multi-panel foldable armored panels may extend upwards, above the interface portion of the ATM 200. In such cases, the rear armored panel 212, first side foldable armored panel 214 and second side foldable armored panel 216 may comprise rear, first side and second side vertical extension panels, respectively (not shown). Such vertical extension panels may be shaped essentially with the same thickness and length as the multi-panel foldable armored panels. In some cases, the first side and second side vertical extension panels may be pivotally connected to the rear vertical extension panel by a first hinge set and a second hinge set (not shown) respectively. Such hinge sets comprise at least two hinges each, designed to be a binding element which binds between the first side and second side vertical extension panels to the rear armored panel 212 a to a continuous structure and allow the swinging movement as the first side and second side vertical extension panels unfolds and folds. In such exemplary cases, the vertical extension panels may surround the interface section 202 of the ATM 200.

In some embodiments of the invention, the material forming the multi-panel foldable armor 210 may comprise steel, such as plate steel, stainless steel, and abrasion-resistant (AR) plate steel. In other embodiments of the invention the material forming the multi-panel foldable armor 210 may comprise aluminum or aluminum alloy, which provide physical strength and low weight. Thus, it was the intention of the inventor to give an armor for ATM's with dedicated material configured to provide physical strength which protects the ATM, low weight, and low cost. In some embodiments of the invention, the multi-panel foldable armored panels of the multi-panel foldable armor 210 such as such as the bottom foldable armored panel 218, rear armored panel 212, front foldable armored panel 219, second side foldable armored panel 216, and the first side foldable armored panel 214, are formed as planer metal sheets, pivotally connected to each other.

In some cases, the weight of the multi-panel foldable armor 210 including all the multi-panel foldable armored panels is below 30 Kilograms (Kgs). In possible cases, the weight of the multi-panel foldable armor 210 is in the range of between 15 Kgs and 20 Kgs. In some embodiments of the invention, the weight of the multi-panel foldable armor is below the maximum package weight limit imposed by some commercial freight carriers. In further embodiments of the invention, the weight of the multi-panel foldable armor 210 enables the multi-panel foldable armor 210 to be shipped by air. Thus, the shipping costs for the multi-panel foldable armor 210 may be low due to the low weight. In some cases, the dimensions of the entire multi-panel foldable armor 210 in cases the multi-panel foldable armor 210 is at a folded-position are below 55 CM wide, 100 CM high and 20 CM thick. Since the multi-panel foldable armored panels are folded and stacked together, shipping of the multi-panel foldable armor 210 is more efficient and cost conscious relating to other armors.

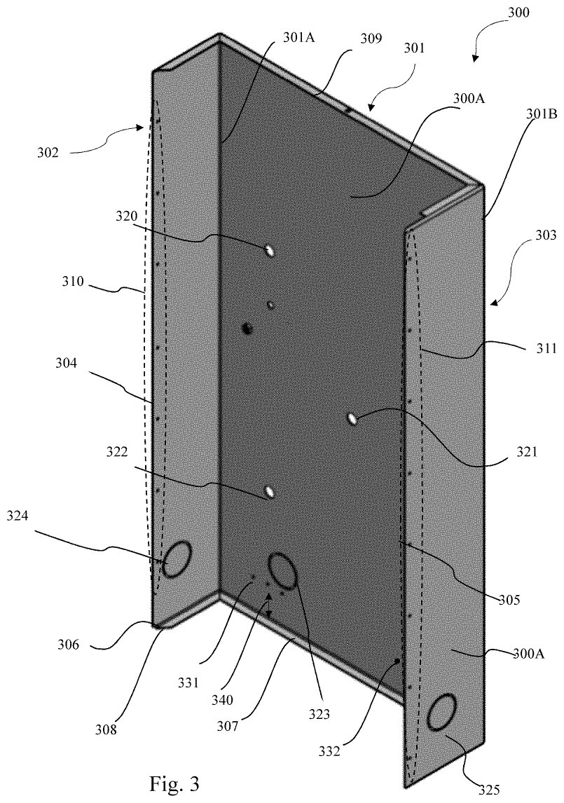

FIG. 3 discloses a rear armored panel of a multi-panel foldable armor, according to exemplary embodiments of the subject matter. FIG. 3 shows a rear armored panel 300 configured to be pivotally connected to other foldable armored panels. In some cases, rear armored panel 300 may be pivotally connected to the bottom, first side and the second side foldable armored panels (not shown). In some cases, the rear armored panel 300 is configured to be placed vertically to a horizontal surface and/or adjacent to a vertical surface. In some cases, the rear armored panel 300 is utilized as an anchor for other foldable armored panels of the multi-panel foldable armor, and is configured to remain stationary in case the other foldable armored panels of the multi-panel foldable armor rotate. In some embodiments of the invention, the rear armored panel 300 comprises a rear internal surface 300A, a rear armored panel 301, a rear panel first lateral section 302 and a rear panel second lateral section 303. In some cases, the rear armored panel 300 is sized to contain the rest of the multi-panel foldable armored panels between the rear panel first and second lateral sections 302 and 303 in cases the multi-panel foldable armor is in a folded-position.

The rear panel first lateral section 302 extends perpendicularly from a rear first lateral edge 301A of the rear armored panel 301. The rear panel first lateral section 302 comprises a first lateral front edge 304 at a front side of the rear panel first lateral section 302. The rear panel second lateral section 303 extends perpendicularly from a rear second lateral edge 301B of the rear armored panel 301 and comprises a second lateral front edge 305 at the front side of the rear panel second lateral section 303. In some cases, the rear panel first and second lateral sections 302 and 303 extend parallelly towards the front side of the rear armored panel 300. In some cases, the rear panel second lateral section 303 is longer than the rear panel first lateral section 302. In some cases, the rear panel second lateral section 303 is longer than the rear panel first lateral section between 1.5 CM and 2.5 CM.

In some embodiments of the invention, the rear armored panel 300 comprises a rear panel bottom edge 306. In some cases, a rear panel bottom protrusion 307 protrudes perpendicularly from the rear panel bottom edge 306, beyond the normal surface of the rear internal surface 300A and towards the middle of the rear armored panel 300. In some cases, the rear panel bottom protrusion 307 extends between 0.5 CM and 1.5 CM and forms a U-shaped rail adjacent to the rear panel bottom edge 306. In some cases, the rear panel bottom protrusion 307 shares the same plane as the rear panel bottom edge 306 (adjacent to the horizontal surface). In some cases, the rear panel bottom protrusion 307 comprises a first triangular edge 308 and a second triangular edge (not shown) adjacent to the first lateral front edge 304 and the second lateral edge 305. In some cases, a rear panel top protrusion 309 protrudes from a top edge of the rear armored panel 300. In some cases, the rear panel top protrusion 309 is shaped in a similar manner to the rear panel bottom protrusion 307.

In some embodiments of the invention, the rear panel first lateral section 302 comprises a rear first lateral hinge hole set 310 and the rear panel second lateral section 303 comprises a rear second lateral hinge hole set 311. The rear first lateral hinge hole set 310 and rear second lateral hinge hole set 311 comprise two or more holes located adjacent to the rear first and second lateral front edges 304 and 305, respectively. In some cases, the holes of the rear first lateral hinge hole set 310 and rear second lateral hinge hole set 311 are configured to contain hinge connectors for enabling the second hinge set to bind the rear first and second lateral sections 302 and 303 with the first and second side foldable armored panels of the multi-panel foldable armor (not shown) to a continuous structure. In such cases, the first side foldable armored panel may be pivotally connected by hinges to the rear panel first lateral section 302 using the rear first lateral hinge hole set 310. The second side foldable armored panel (not shown) may be pivotally connected by the second hinge-set (not shown) to the rear panel second lateral section 303 using the rear second lateral hinge hole set 311. In some cases, the hinges binding the rear armored panel 300 to the first side foldable armored panel and to the second side foldable armored panel allow the first side foldable armored panel to rotate up to 180 degrees from the rear armored panel 300. In some cases, the hinges may be located on the rear internal surface 300A of the rear armored panel 300.

In some cases, a number of connector holes such as connector holes 320, 321 and 322 are located at the rear armored panel 301. The connector holes 320, 321 and 322 extend through the width of the rear armored panel 301 and designed to enable one or more connectors, such as bolts, to connect the rear armored panel 300 to a vertical surface situated behind the rear armored panel 300. In some embodiments of the invention, the rear armored panel 300 comprises one or more apertures such as apertures 323, 324 and 325, for enabling cables to extend from within the multi-panel foldable armor to a power source or other plugs located outside the multi-panel foldable armor. In some cases, two or more sets of rear hinge holes (not shown) are located at the rear armored panel 301. The two or more sets of rear hinge holes are configured to enable two or more hinges to be coupled to the rear armored panel 301. In some cases, a first set of rear back hinge holes 331 and a second set of rear back hinge holes 332 (only one hole of the hinge holes 332 is shown) are located at the rear armored panel 301. In some cases, the first set of rear back hinge holes 331 and a second set of rear hinge holes are situated at the same horizontal plane which is parallel to a horizontal surface, and in a first distance 340 from the rear panel bottom edge 306. In some cases, the first distance 340 may be in the range of between 5 CM and 6 CM from the rear panel bottom edge 306.

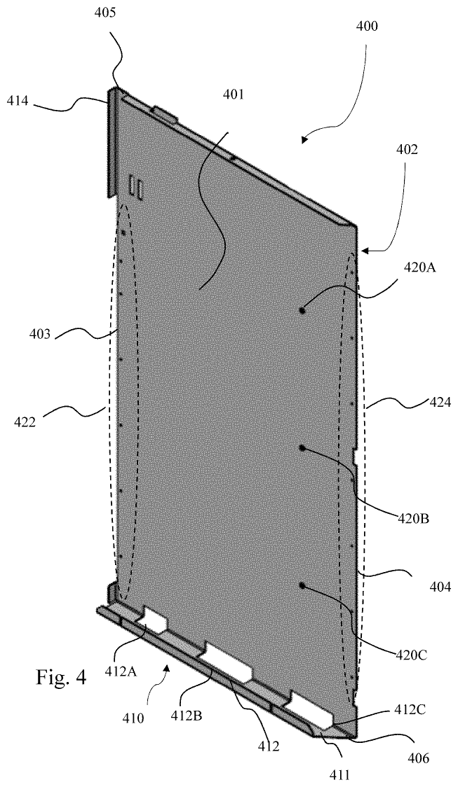

FIG. 4 discloses a first side foldable armored panel of a multi-panel foldable armor, according to exemplary embodiments of the subject matter. FIG. 4 shows a first side foldable armored panel 400 of the multi-panel foldable armor, designed to be pivotally connected to a rear armored panel (not shown). The first side foldable armored panel 400 comprises a first side internal surface 401, a first side external surface 402, a first side front edge 403, a first side rear edge 404, a first side top edge 405 and a first side bottom edge 406. In some cases, the first side foldable armored panel 400 may comprise one or more fasteners, such as fasteners 420A, 420B and 420C, located at the first side external surface 402 of the first side foldable armored panel 400. The fasteners 420A, 420B and 420C are designed to enable a person to connect the first side foldable armored panel 400 to a second side foldable armored panel (not shown) of another foldable armor by a connector fitting the type of fasteners. For example, fasteners 420A, 420B and 420C may be connected to other fasteners located on other foldable armored panels by a threaded bolt and/or other connectors known to a person having skill in the art. In such exemplary cases, two or more foldable armors may be attached together to create an ATM cluster, which may be tougher to temper than a single foldable armor.

In some embodiments of the invention, the first side bottom edge 406 comprises a first side rail member 410. In some embodiments of the invention, the first side rail member 410 elongated perpendicularly from the first side bottom edge 406. In some embodiments of the invention, the first side rail member 410 comprises a first side bottom horizontal protrusion 411 and a first side bottom vertical protrusion 412. In some cases, the first side bottom horizontal protrusion 411 extends perpendicularly to the first side foldable armored panel 400 and in some cases substantially parallel to a horizontal surface. The first side bottom vertical protrusion 412 extends perpendicularly upwards from a distal edge of the first side bottom horizontal protrusion 411 towards the first side top edge 405. In some embodiments of the invention, the first side bottom vertical protrusion 412 may be parallel to the first side internal surface 401 of the first side foldable armored panel 400. In some cases, the first side bottom horizontal protrusion 411 may be shaped identically to the rear bottom horizontal protrusion of the rear armored panel (not shown), as aforementioned in FIG. 3. In some cases, the first side bottom vertical protrusion 412 is shaped in a length of between 1.5 CM and 2.5 CM. In some cases, the first side bottom horizontal protrusion 411 comprises inclined triangular edge adjacent to the first side rear edge 404.

In some embodiments of the invention, recessed squares 412A, 412B and 412C are located at the first side foldable armored panel 400. the recessed squares house the bottom L-shaped extension of the second side foldable armored panel). In some cases, the recessed squares 412A 412B and 412C are located at the first side bottom horizontal protrusion 411 and penetrate through the first side internal surface 401 to the first side external surface. In some cases, the recessed squares 412A, 412B and 412C may be adapted to house a part of the second side foldable armored panel (not shown) of the multi-panel foldable armor, for example, in cases the multi-panel foldable armor is in a folded-position.

In some embodiments of the invention, the first side front edge 403 of the first side foldable armored panel 400 comprises a first side front perpendicular element 414. The first side front perpendicular element 414 elongated perpendicularly from the first internal surface 401. The first side front perpendicular element 414 may be configured to prevent access to the hinges binding the first side foldable armored panel 400 to the front foldable armored panel (not shown) in cases the door is shorter than the first side foldable armored panel.

In some cases, a front hinge hole set 422 is vertically located below the first side front perpendicular element 414 and along a vertical axis parallel to the first side front edge 403. The front hinge hole set 422 comprises a number of holes configured to allow hinges to bind the first side foldable armored panel 400 and the front the multi-panel foldable armored panel (not shown) to a continuous structure and allow the swinging movement as the front foldable armored panel opens and closes. In some cases, the hinges may be configured to enable the front foldable armored panel to rotate up to about 270 degrees from the first side foldable armored panel 400 rear armored panel. In some cases, the holes of the front hinge hole set 422 are located essentially 1 Cm from the first side front edge 403.

In some cases, a first rear hinge hole set 424 may be vertically located along a vertical axis parallel to the first side rear edge 404. The first rear hinge hole set 424 comprises a number of holes configured to allow hinges to bind the first side foldable armored panel 400 with the rear armored panel (not shown) to a continuous structure and allow the swinging movement as the front foldable armored panel opens and closes. The first rear hinge hole set 424 can be configured to enable the first side foldable armored panel 400 to rotate up to essentially 110 degrees around the rear armored panel. In some cases, the holes of the first rear hinge hole set 424 are located in essentially 1 CM from the first side rear edge 404.

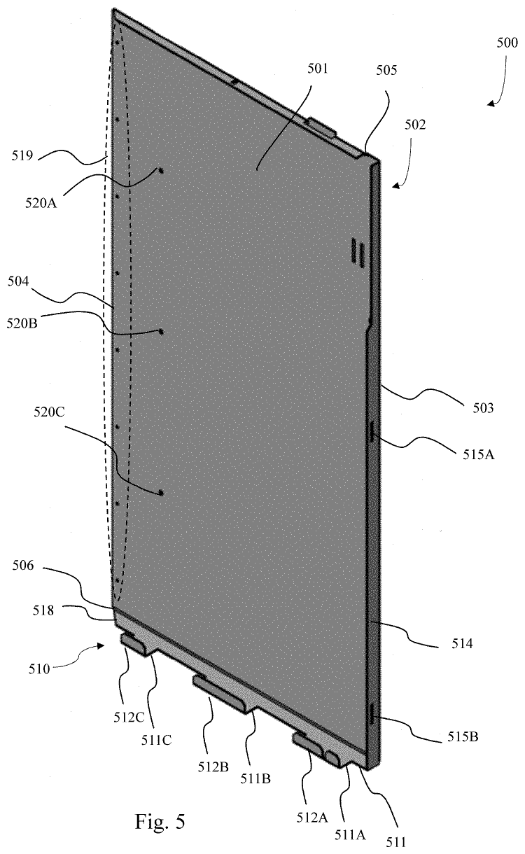

FIG. 5 discloses a second side foldable armored panel of the multi-panel foldable armor, according to exemplary embodiments of the subject matter. FIG. 5 shows a second side foldable armored panel 500 of the multi-panel foldable armor, configured to be pivotally connected to the rear armored panel (not shown). In some embodiments of the invention, the second side foldable armored panel 500 comprises a second side internal surface 501, a second side external surface 502, a second side front edge 503, a second side rear edge 504, a second side top edge 505 and a second side bottom edge 506. In some cases, one or more fasteners, such as fasteners 520A, 520B and 520C, may be located at the second side external surface 502 of the second side foldable armored panel 500. In such cases, the fasteners may be configured to enable a connector to connect the second side foldable armored panel 500 to a first side foldable armored panel (not shown) of another multi-panel foldable armor as aforementioned.

In some embodiments of the invention, the second side bottom edge 506 comprises a second side rail member 510. In some cases, the second side rail member 510 comprises a second side bottom horizontal protrusion 511. In some cases, the second side bottom horizontal protrusion 511 extends perpendicularly to the second side foldable armored panel 500 and in some cases substantially parallel to a horizontal surface. In some cases, the second side bottom horizontal protrusion 511 may be structured with a smaller width than the width of the first side rail member (not shown. In some cases, the second side bottom horizontal protrusion 511 comprises inclined triangular edge 518 adjacent to the second side rear edge 504. In some embodiments of the invention, the second side bottom horizontal protrusion 511 comprises second side extension arms 511A, 511B and 511C adapted to fit inside the recessed squares that are located at the first side foldable armored panel (not shown). In some cases, the second side extension arms 511A, 511B and 511C further extend from the second side bottom horizontal protrusion 511 and are spaced apart from each other in an identical manner to the spacing of the recessed squares situated at the first side foldable armored panel.

In some cases, each of the second side extension arms 511A, 511B and 511C comprise a second side bottom vertical protrusion 512A, 512B and 512C, respectively, extending vertically upwards from the internal end of the second side extension arms 511A, 511B and 511C. The second side bottom vertical protrusions 512A, 512B and 512C are shaped to fit inside the recessed squares located at the first side internal surface of the first side foldable armored panel. In some cases, the location of the second side bottom vertical protrusions 512A, 512B and 512C at the second side bottom horizontal protrusion 511 matches the location of the squared recesses located throughout the length of the first side rail member (not shown). Thus, in cases the first side foldable armored panel is positioned against the second side foldable armored panel 500, the second side bottom vertical protrusions 512A, 512B and 512C can fit inside the squared recesses, such that the first side and the second side foldable armored panels may be stacked adjacently to one another.

In some cases, a second rear hinge hole set 519 may be located vertically along a vertical axis in parallel to the second side rear edge 504. The second rear hinge hole set 519 comprises a number of holes configured to enable hinges to bind the second side foldable armored panel 500 with the rear armored panel (not shown) to a continuous structure and allow the swinging movement as the second side foldable armored panel opens and closes. The second rear hinge hole set 519 can be configured to enable the second side foldable armored panel 500 to rotate up to essentially 110 degrees around the rear armored panel. In some cases, the holes of the second rear hinge hole set 519 are located in essentially 1 CM from the second side rear edge 504.

In some embodiments of the invention, the second side front edge 503 comprises a second side front perpendicular element 514. The second side front perpendicular element 514 may extend from the second side front edge 503 perpendicularly to the second side foldable armored panel 500 and from the second side internal surface 501 thereof. The second side front perpendicular element 514 may extend from the second side top edge 505 and down along the second side front edge 503 to the second side bottom edge 506. In some embodiments of the invention, the second side front perpendicular element 514 comprises at least one front recess, such as second side front recesses 515A and 515B. In some cases, the front recesses 515A and 515B are configured to enable a part of the front foldable armored panel to be inserted into the front recesses 515A and 515B.

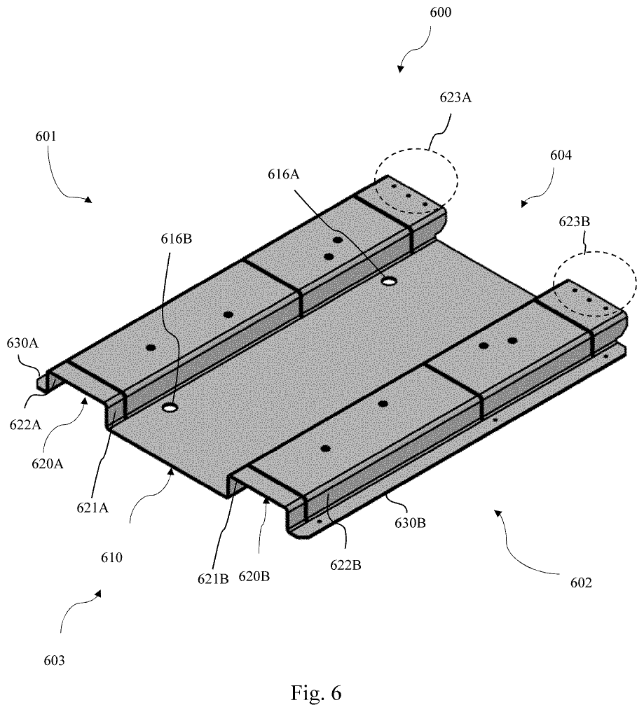

FIG. 6 discloses a bottom foldable armored panel of the multi-panel foldable armor, according to exemplary embodiments of the subject matter. FIG. 6 shows a bottom foldable armored panel 600 comprising a first lateral side 601, a second lateral side 602, a front side 603 and a rear side 604. The bottom foldable armored panel 600 is configured to be connected to the rear armored panel of the multi-panel foldable armor. In some cases, the bottom foldable armored panel 600 is adapted to be located on a horizontal surface and mounted on the first side foldable armored panel (not shown) and the second side foldable armored panel (not shown). Thus, the bottom foldable armored panel 600 can bind the multi-panel foldable armored panels to a firm and steady structure of the multi-panel foldable armor in an unfolded-position. Such a foldable armor in an unfolded-position is composed of a rear, first side and second side foldable armored panels positioned vertically to a horizontal surface and mounted by the bottom foldable armored panel 600 positioned parallelly to the horizontal surface. In such cases, the bottom foldable armored panel 600 is placed on a horizontal surface leaning against the first and second side rail members of the first side and the second side foldable armored panels (not shown).

The bottom foldable armored panel 600 comprises a central member 610, a first elevated platform 620A extending from the first lateral side 601 of the central member 610, a second elevated platform 620B extending from the second lateral side 602 of the central member 610, a bottom first rail member 630A extending from the first lateral side 601 of the first elevated platform 620A and a bottom second rail member 630B extending from a second lateral side 602 the second elevated platform 620B. In some cases, the first elevated platform 620A and the second elevated platform 620B are connected to the central member 610 by a first long arm 621A and a second-long arm 621B, respectively. The bottom first rail member 630A and the bottom second rail member 630B extend perpendicularly from a first short arm 622A and a second short arm 622B of the first elevated platform 620A and the second elevated platform 620B, respectively. In some cases, the first elevated platform 620A and the second elevated platform 620B can be situated on a same plane above and parallel to the central member 610. In some cases, the bottom first rail member 630A and the bottom second rail member 630B are situated on a same plane above and parallel to the central member 610 and below and parallel to the first and second elevated platforms 620A and 620B.

In some embodiments of the invention, the central member 610 is shaped as a rectangle and may comprise at least one aperture (not shown) situated therein. In some cases, the central member 610 comprises a plurality of apertures (of which only two 616A, 616B are shown) for allowing ground connectors to connect the bottom foldable armored panel 600 to a horizontal surface below the multi-panel foldable armor. In some cases, the first and second long arms 621A and 621B are longer than the first and second short arms 622A and 622B. in such cases, the first and second long arms 621A and 621B are longer than the first and second short arms 622A and 622B by the width of first and second side rail members thickness. In such cases, the bottom first rail member 630A and the bottom second rail member 630B may be in contact with the horizontal section of the first and second side rail members of the first and second side foldable armor panels.

In some cases, the first and second elevated platforms 620A and 620B are elevated from the central member 610 by a distance larger than the length of the first or second side bottom vertical protrusions of the first and second side lateral armor panels (not shown). In such cases, the first and second elevated platforms 620A and 620B are shaped to contain the rear bottom vertical protrusion of the first and second lateral armor panels. In some embodiments of the invention, the first and second elevated platforms 620A and 620B are identical to each other. In possible embodiments of the invention, the first and second elevated platforms 620A and 620B are mirror images of each other. In some embodiments of the invention, the first and second elevated platforms 620A and 620B are formed with a smooth texture, configured to ease sliding devices, such as ATMs.

In some cases, a first set of bottom hinge holes 623A can be located adjacent to the rear side 604 of the first elevated platform 620A and a second set of bottom hinge holes 623B can be located adjacent to the rear side 604 of the second elevated platform 620B. The first set of bottom hinge holes 623A and a second set of bottom hinge holes 623B are configured to contain bottom hinges to allow the bottom foldable armored panel 600 to be pivotally connected in a vertical manner to the rear back hinge holes of the rear armored panel (not shown). In some cases, the bottom hinges are configured to enable the bottom foldable armored panel 600 to rotate vertically essentially in 90 degrees about the rear armored panel. In such cases, the bottom foldable armored panel 600 is configured to allow movements from a folded-position to an unfolded-position. Thus, in a folded-position a top side 605 of the bottom foldable armored panel 600 may contact the internal surface of the rear armored panel, and in an unfolded posion the bottom side of the bottom foldable armored panel 600 may contact the horizontal surface below the multi-panel foldable armor and about perpendicular to the rear armored panel.

In some cases, at least one ground aperture is located at the bottom foldable armored panel 600 for allowing at least one ground connector to pass through the at least one ground aperture and into a horizontal surface below the multi-panel foldable armor. In such cases, a horizontal surface connector may secure the multi-panel foldable armor via the bottom foldable armored panel 600 to a horizontal surface. In some cases, the bottom foldable armored panel 600 comprises at least one ATM aperture for allowing at least one ground connector to pass from the ATM, via the at least ATM aperture and into a horizontal surface below the multi-panel foldable armor, and thereby connects the ATM and the multi-panel foldable armor directly to a horizontal surface.

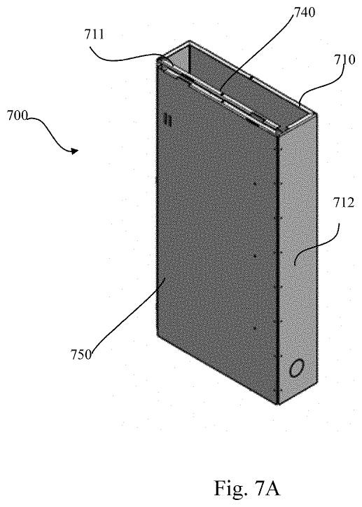

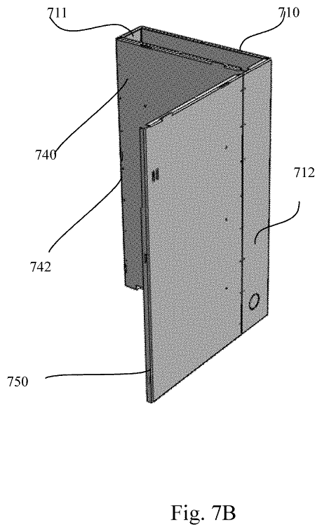

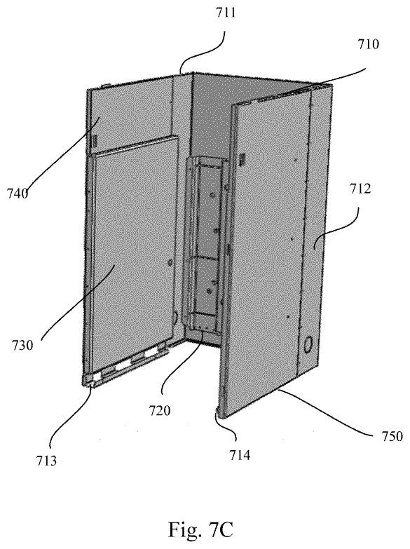

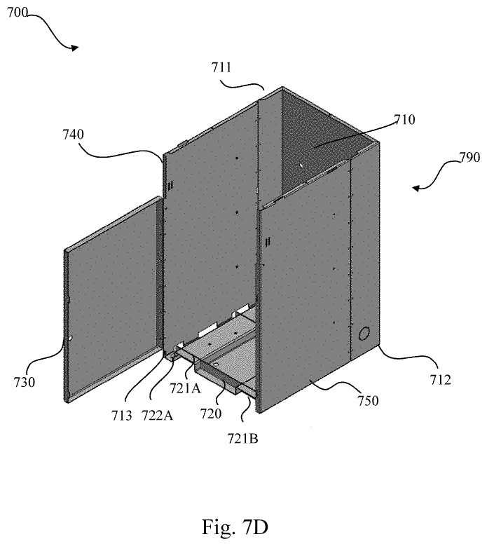

FIG. 7A discloses the foldable armor with multiple foldable armored panels bound in a continuous structure at a folded position, according to exemplary embodiments of the subject matter.

FIG. 7A shows a foldable armor 700 in a folded position such that the foldable armored panels of the foldable armor 700 are folded horizontally one next to the other. A rear foldable armored panel 710 is at the rear side of the foldable armor 700 and houses other foldable armored panels. In some cases, the housing of the bottom foldable panel (not shown) can be between a first lateral section 711 and the rear foldable armored panel 710. The bottom foldable armored panel may be positioned upwards around two or more rear hinges (not shown) and connected to the rear foldable armored panel 710. The foldable armor 700 also comprises a door foldable armored panel 730 situated next to the bottom side of the bottom foldable armored panel. The door foldable armored panel 730 can be connected to a first side foldable armored panel 740 by a plurality of first side front (not shown). The door foldable armored panel 730 is situated against a first side internal surface of the first side foldable armored panel 740. A second side foldable armored panel 750 is folded over the first side foldable armored panel 740 and situated next a first side outer surface side at a folded position.

The foldable armor 700 may be configured such that, at folded-position the rear foldable armored panel 710 extends perpendicularly to a horizontal surface. The bottom foldable armored panel (not shown) is pivotally connected to the rear foldable armored panel 710, wherein the bottom foldable armored panel (not shown) is folded over the rear foldable armored panel 710. At the folded-position, the first side foldable armored panel 740 is pivotally connected to the rear foldable armored panel 710, wherein the rear foldable armored panel 710 is folded over the folded bottom foldable armored panel wherein the folded bottom foldable armored panel is folded over the rear foldable armored panel 710, and wherein. The foldable armor 700 may also comprise a front foldable armored panel (not shown) pivotally connected to the first side foldable armored panel 740, wherein the front foldable armored panel is folded over the first side foldable armored panel 740. At the folded-position, the second side foldable armored panel 750 may also be pivotally connected the rear foldable armored panel 710, wherein the second side foldable armored panel 750 can be folded over the folded first side foldable armored panel 740, wherein the folded first side foldable armored panel 740 is folded over the folded bottom side foldable armored panel, and wherein the folded bottom foldable armored panel is folded over the rear foldable armored panel 710.

FIG. 7B discloses the multi-panel foldable armor with multiple foldable armored panels bound in a continuous structure arranged in a transitional layout, denoted as a first unfolding position, which leads to the unfolded-position of the multi-panel foldable armor, according to FIG. 7A. FIG. 7B shows a second side foldable armored panel 750 at a first unfolding position. The second side foldable armored panel 750 is situated on the same vertical plane as the second lateral section 712 of the rear armored panel 710. In the first unfolding position, the first side foldable armored panel 740 is folded over the rear armored panel 710.

FIG. 7C discloses the multi-panel foldable armor with multiple foldable armored panels bound in a continuous structure arranged in a transitional layout, denoted as a second unfolding position, which leads to the unfolded-position of the multi-panel foldable armor, according to FIG. 7A. FIG. 7C shows a second side foldable armored panel 750 at a second unfolding position. The second side foldable armored panel 750 is situated on the same vertical plane as the second lateral section 712 of the rear armored panel 710. The second side foldable armored panel 750 is situated on the same vertical plane as the second lateral section 712 of the rear armored panel 710. The first side foldable armored panel 740 is positioned at an unfolded-position and situated on the same vertical plane as the first lateral section 711 of the rear armored panel 710. In the second unfolding position, the bottom foldable armored panel 720 is folded over the rear armored panel 710 and the front foldable armored panel 730 is folded over the first side foldable armored panel 740. The first side rail member 713 of the first side foldable armored panel 740 is exposed to accommodate the bottom foldable armored panel 720 in cases the bottom foldable armored panel 720 swings downwardly and situated in an unfolded-position.

FIG. 7D discloses the multi-panel foldable armor with multiple foldable armored panels bound in a continuous structure in an unfolded-position, according to FIG. 7A. FIG. 7D shows a multi-panel foldable armor 700 in an unfolded-position. The multi-panel foldable armor 700 comprises the second side foldable armored panel 750 at an unfolded-position. In such case, the second side foldable armored panel 750 can be situated on the same vertical plane as the second lateral section 712 of the rear armored panel 710. The first side foldable armored panel 740 is at an unfolded-position, situated on the same vertical plane as the first lateral section 711 of the rear armored panel 710. The front foldable armored panel 730 is at an unfolded-position and configured to rotate about 270 degrees from the first side foldable armored panel 740. The multi-panel foldable armor 700 also comprise the bottom foldable armored panel 720 situated at an unfolded-position on top of the first and second side rail members 713 and 714. In some cases, the first side rail member 713 may be situated underneath a first elevated platform 721A and a bottom first rail member 722A of the bottom foldable armored panel 720 and the second side rail member 714 is situated underneath a second elevated platform 721B and a bottom second rail member (not shown) of the bottom foldable armored panel 720.

In some embodiments of the invention, the multi-panel foldable armor 700 may be structured as a multi-panel structure at the opposite direction. In such cases, the front foldable armored panel 730 can be connected to the second side foldable armored panel 750 by a scond side front hinges (not shown). Thus, the multi-panel foldable armor 700 may be configured to allow a folded-position of the multi-panel foldable armor 700 wherein the front foldable armored panel 730 folds over the second side foldable armored panel, the second side foldable armored panel 750 folds over the rear armored panel 710, and the first side foldable armored panel 740 folds over the folded the second side foldable armored panel 750.

In some cases, the front foldable armored panel 730 can be pivotally connected by a forth hinge set (not shown) to the first side foldable armored panel 740, wherein the forth hinge set allows the front foldable armored panel 730 to be situated perpendicularly to the first side foldable armored panel 740.

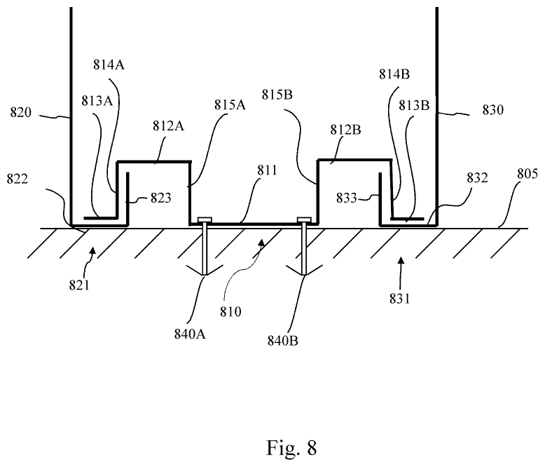

FIG. 8. shows a cross-section of a lower section of a multi-panel foldable armor in an unfolded-position, according to exemplary embodiments of the subject matter. FIG. 8 shows a vertical cross-section of a lower section of a foldable armor in an unfolded-position comprising a bottom foldable armored panel 810, a first side foldable armored panel 820 and a second side foldable armored panel 830. The bottom foldable armored panel 810 is at an unfolded-position. The bottom foldable armored panel 810 is situated perpendicularly to the rear armored panel and at least partly located on a horizontal surface 805. In some cases, the bottom foldable armored panel 810 is also placed on a first side rail member 821 of the first side foldable armored panel 820 and on a second side rail member 831 of a second side foldable armored panel 830. The first side rail member 821 comprises a first side bottom horizontal protrusion 822 and a first side bottom vertical protrusion 823 and the second side rail member 831 comprises a second side bottom horizontal section 832 and a second side bottom vertical section 833. In some cases, the second side bottom vertical section 833 may comprise second side bottom vertical sections spaced apart from each other.

The bottom foldable armored panel 810 comprises a central member 811 located on the same plane of the first side bottom protrusion 822 and the second side bottom horizontal section 832. In some embodiments of the invention, the first side bottom protrusion 822 may be situated underneath and adjacent to a bottom first rail member 813A of the bottom foldable armored panel 810. In some cases, the bottom first rail member 813A may extend from a first side short arm 814A of a first side elevated platform 812A to the first side foldable armored panel 820, wherein a first side short arm 814A connects the first side intermediate platform 813A to the first side elevated platform 812A. The first side bottom vertical protrusion 823 is located in a space formed by the first side elevated platform 812A, the first side short arm 814A, a first side long arm 815A, and the horizontal surface 805. In such exemplary cases, the bottom foldable armored panel 810 prevents the first side foldable armored panel 820 from pivoting inwards and outwards around a first side rear hinges (not shown).

In some embodiments of the invention, the second side bottom horizontal section 832 is situated underneath and adjacent to a bottom second rail member 813B of the bottom foldable armored panel 810. In some cases, the bottom second rail member 813B may extend from the second side short arm 814B to the second side foldable armored panel 830, wherein the second side short arm 814B connects the bottom second rail member 813B to a second side elevated platform 812B. Also, the second side bottom vertical section 833 is located in a space formed by the second side elevated platform 812B, the second side short arm 814B, a second side long arm 815B, and the horizontal surface 805. In such exemplary cases, the bottom foldable armored panel 810 prevents the second side foldable armored panel 830 from pivoting inwards and outwards around the rear armored panel.

In some embodiments of the invention, the bottom foldable armored panel 810 comprises one or more holes (not shown) extending vertically through the central member 811. In some cases, one or more ground connectors, such as ground connectors 840A and 840B, are housed at the one or more holes. Ground connectors 840A and 840B are configured to secure the multi-panel foldable armor to the horizontal surface 805. For example, Ground connectors 840A and 840B may be jumbo screws, concrete anchors and the like.

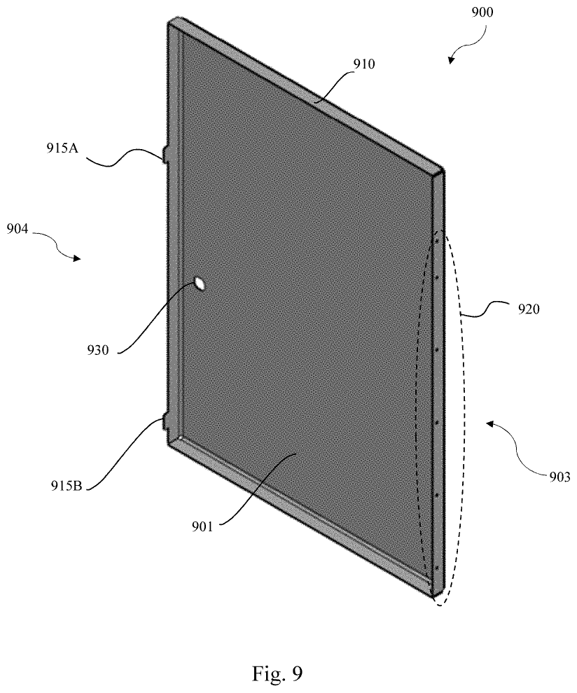

FIG. 9 discloses a front foldable armored panel of the multi-panel foldable armor, according to FIG. 7C. FIG. 9 shows a front foldable armored panel 900 comprising a front internal surface 901. The front foldable armored panel 900 is formed from a single panel of uniform thickness. The front foldable armored panel 900 is configured to be utilized as an openable door for the multi-panel foldable armor. As such, the front foldable armored panel 900 is configured to be pivotally connected to one of the side foldable armored panels. In some cases, a front frame 910 extends perpendicularly from the front internal surface 901 of the front foldable armored panel 900 through at least a part of the circumference of the front foldable armored panel 900.

In some cases, the front foldable armored panel 900 comprises a door hinge hole set 920 located on a front first lateral side 903 of the front frame 910 for accommodating the forth hinge set (not shown). In some embodiments of the invention, the front foldable armored panel 900 may be pivotally connected to the first side foldable armored panel (not shown) by at least one hinge, of the forth hinge set, which is connected to the front foldable armored panel 900 via the door hinge hole set 920. The at least one hinge may enable the front foldable armored panel 900 to pivot up to 270 degrees around the first side foldable armored panel (not shown). In some cases, at least one front protrusion, such as 915A and 915B, extends from the front first lateral side 903 of the front frame 910 away from the internal surface of the front foldable armored panel 900. In some cases, the more front protrusions 915A and 915B are configured to enter the at least one front recess of the second side foldable armored panel.

In some cases, the front foldable armored panel 900 further comprises a locking mechanism aperture 930 located adjacent to the front second lateral side 904 of the front foldable armored panel 900. In some embodiments of the invention, a locking mechanism (not shown) may be housed at the locking mechanism aperture 930. The locking mechanism can be configured to enable attachment of the front foldable armored panel 900 to the second side foldable armored panel (not shown) and to release the attachment. In some cases, the locking mechanism may be a cam lock and the like. In some cases, the locking mechanism is configured to transit between an unlocked position and locked position. In cases the locking mechanism is at a locked position, at least a part of the locking mechanism is shaped to be situated behind the second side front perpendicular element of the second side foldable armored panel, thereby preventing the front foldable armored panel 900 from pivoting around the first side foldable armored panel.

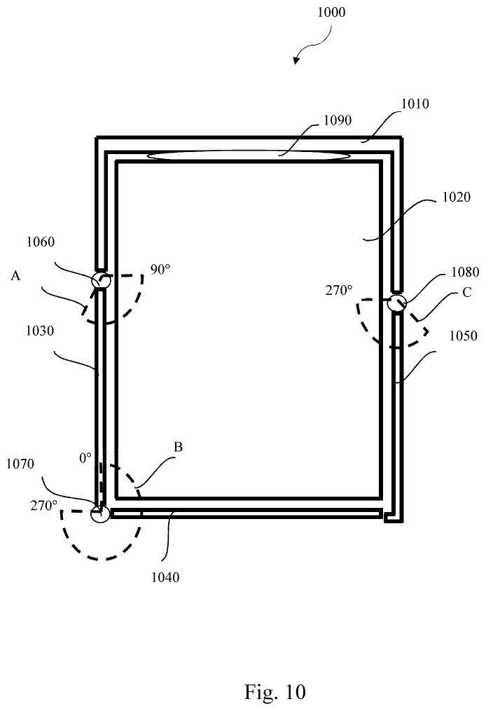

FIG. 10 discloses a horizontal cross-section of a foldable armor in an unfolded-position, according to exemplary embodiments of the subject matter. FIG. 10 shows a horizontal cross-section of a multi-panel foldable armor 1000 in an unfolded-position. The multi-panel foldable armor 1000 comprises a rear armored panel 1010, a bottom foldable armored panel 1020, a first side foldable armored panel 1030, a front foldable armored panel 1040 and a second side foldable armored panel 1050.

In some embodiments of the invention, the rear armored panel 1010 and the first side foldable armored panel 1030 are pivotally connected by a first hinge set 1060. In some cases, the first hinge set 1060 may comprise at least one hinge connected to the internal surfaces of the rear armored panel 1010 and the first side foldable armored panel 1030. In some cases, the rear first hinge set 1060 allows the swinging movement of the first side foldable armored panel 1030, in a horizontal opening angle A. The horizontal A can essentially be between of 90° to 200°. In some embodiments of the invention, the opening angle A of the first hinge set 1060 is about 90° in cases the multi-panel foldable armor 1000 closes to be in a folded-position and about 180° in cases the multi-panel foldable armor 1000 opens to be in an unfolded-position.

In some embodiments of the invention, the first side foldable armored panel 1030 and the front foldable armored panel 1040 are pivotally connected by a forth hinge set 1070. In some cases, the forth hinge set 1070 may comprise least one hinge connected to the internal surface of the first side foldable armored panel 1030 and to the internal surface or first lateral edge of the front foldable armored panel 1040. In some cases, the forth hinge set 1070 allows the swinging movement of the front foldable armored panel 1040 in a horizontal opening angle B. The horizontal opening angle B can be essentially between 0° and 270°. In some embodiments of the invention, the opening angle B of the forth hinge set 1070 is about 0° in cases the multi-panel foldable armor 1000 closes to be in a folded-position, wherein the front foldable armored panel 1040 is folded over the first side foldable armored panel 1030. The opening angle B of the forth hinge set 1070 can be about 90°, perpendicularly to the first side foldable armored panel 1030 in cases the multi-panel foldable armor 1000 is at an unfolded-position.

In some embodiments of the invention, the rear armored panel 1010 and the second side foldable armored panel 1050 are pivotally connected by a second hinge set 1080. In some cases, the second hinge set 1080 may comprise at least one hinge connected to the internal surfaces of the rear armored panel 1010 and the second side foldable armored panel 1050. In some cases, the second hinge set 1080 allows the swinging movement of the second side foldable armored panel 1050 in a horizontal opening angle C. The horizontal opening angle C can be essentially between 160° and 270°. In some embodiments of the invention, the opening angle C of the second hinge set 1080 is about 270° in cases the multi-panel foldable armor 1000 closes to be in a folded-position and about 180° in cases the multi-panel foldable armor 1000 opens to be in an unfolded-position.

In some embodiments of the invention, the rear armored panel 1010 and the bottom foldable armored panel 1020 are pivotally connected by a third hinge set 1090. In some cases, the third hinge set 1090 may comprise at least one hinge connected to the internal surface of the rear armored panel 1010 and to the top surface of the bottom foldable armored panel 1020. In possible cases, the at least one hinge comprises two hinges connected to both a first elevated platform and a second elevated surface (not shown) of the bottom foldable armored panel 1020. In some cases, the third hinge set 1090 comprises a vertical opening angle of essentially between 0° and 90°. In some embodiments of the invention, the opening angle of the third hinge set 1090 is essentially about 0° in cases the multi-panel foldable armor 1000 is in a folded-position. In such cases, the bottom foldable armored panel 1020 can be adjacent and in some cases touch the rear armored panel 1010. The second hinge set 1080 can be essentially about 90° in cases the multi-panel foldable armor 1000 is in an unfolded-position. In such cases, the bottom foldable armored panel 1020 can be essentially perpendicular, and in some cases touch the rear armored panel 1010.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

What is claimed is:

1. A multi-panel foldable armor comprises multiple foldable armored panels bound in a continuous structure configured to be altered between a folded-position and an unfolded-position, wherein each foldable armored panel is bound to at least one adjacent foldable armored panel by a hinge set, comprising:
a rear armored panel extends perpendicularly to a horizontal surface;
a bottom foldable armored panel pivotally connected by a third hinge set to the rear armored panel, wherein the third hinge set is configured such that at the folded-position the bottom foldable armored panel is folded over the rear armored panel, and wherein the third hinge set is configured such that at the unfolded-position the bottom foldable armored panel is situated perpendicularly to the rear armored panel;
a first side foldable armored panel pivotally connected by a first hinge set to the rear armored panel, wherein the first hinge is configured such that at the folded-position the first side foldable armored panel is folded over the folded bottom foldable armored panel wherein the folded bottom foldable armored panel is folded over the rear armored panel, and wherein the first hinge is configured such that at the unfolded-position the first side foldable armored panel is situated perpendicularly to the rear armored panel;
a front foldable armored panel pivotally connected by a forth hinge set to the first side foldable armored panel, wherein the forth hinge set is configured such that at the folded-position the front foldable armored panel is folded over the first side foldable armored panel, and wherein the forth hinge set is configured such that at the unfolded-position the front foldable armored panel is situated perpendicularly to the first side foldable armored panel; and
a second side foldable armored panel pivotally connected by a second hinge set to the rear armored panel, wherein the second hinge set is configured such that at the folded-position the second side foldable armored panel is folded over the folded first side foldable armored panel wherein the folded first side foldable armored panel is folded over the folded bottom foldable armored panel wherein the folded bottom foldable armored panel is folded over the rear armored panel, and wherein the second hinge set is configured such that at the unfolded-position the second side foldable armored panel is situated perpendicularly to the rear armored panel,
wherein at unfolded-position the bottom foldable armored panel situated perpendicularly to the rear armored panel is mounted to the first side foldable armored panel and thereby prevents from the first side foldable armored panel to rotate on the first hinge set, and wherein the at unfolded-position the bottom foldable armored panel situated perpendicularly to the rear armored panel is mounted to the second side foldable armored panel and thereby prevents from the second side foldable armored panel to rotate on the second hinge set.

2. The foldable armor of claim 1, wherein the first side foldable armored panel further comprises a first side rail member.

3. The foldable armor of claim 2, wherein the bottom foldable armor further comprises a bottom first rail member.

4. The foldable armor of claim 3, wherein at unfolded-position the bottom first rail member of the bottom foldable armored panel is mounted onto the first side rail member of the first side foldable armored panel.

5. The foldable armor of claim 1, wherein the second side foldable armored panel further comprises a second side rail member.

6. The foldable armor of claim 5, wherein the bottom foldable armor further comprises a bottom second rail member.

7. The foldable armor of claim 6, wherein at unfolded-position the bottom second rail member of the bottom foldable armored panel is mounted onto the second side rail member of the second side foldable armored panel.

8. The foldable armor of claim 1, wherein apertures are located on the bottom side foldable armored panel.

9. The foldable armor of claim 8, wherein the apertures located on the bottom foldable armored panel are configured to allow a passage of a connector from the foldable armor into a horizontal surface below the foldable armor.

10. The foldable armor of claim 1, wherein the second side foldable armored panel is longer than the first side foldable armored panel.

11. The foldable armor of claim 1, wherein the multi-panel foldable armor weighs 50 Kgs or less.

12. The foldable armor of claim 1, wherein the front foldable armored panel further comprises a locking mechanism aperture.

13. The foldable armor of claim 12, wherein the locking mechanism aperture is located adjacent to the front second lateral side.

14. The foldable armor of claim 12, wherein the locking mechanism aperture houses a locking mechanism.

15. The foldable armor of claim 14, wherein the locking mechanism is configured to be held against the second side foldable armored panel wherein the foldable armor is at the unfolded-position.

16. The foldable armor of claim 1, wherein the foldable armored panels are formed with the same thickness.

17. The foldable armor of claim 1, wherein the bottom foldable armored panels is thicker than the rear foldable armored panels.

18. The foldable armor of claim 1, wherein the bottom foldable armored panels is thicker than the first side foldable armored panels.

19. The foldable armor of claim 1, wherein the bottom foldable armored panels is thicker than the second side foldable armored panels.

20. The foldable armor of claim 1, wherein the material forming the multi-panel foldable armor 210 comprises aluminum or aluminum alloy.
